(19) United States
(12) Patent Application Publication
(10) Pub. No.: US 2012/0304880 A1
(43) Pub. Date: Dec. 6, 2012

(54) RECORDING APPARATUS AND RECORDING METHOD

(75) Inventor: Keisuke YAMAYA, Shiojiri-shi (JP)

(73) Assignee: SEIKO EPSON CORPORATION, Tokyo (JP)

(21) Appl. No.: 13/483,214

(22) Filed: May 30, 2012

(30) Foreign Application Priority Data
Jun. 6, 2011 (JP) 2011-126160

(51) Int. Cl. B41F 5/00

(52) U.S. Cl. 101/216; 101/483

(57) ABSTRACT

A recording apparatus including a recording unit capable of performing a recording process in a recording area for various types of recording media, and a transport roller pair capable of transporting the recording media onto the recording area; the transport roller pair includes a drive roller which is provided with a drive roll portion having a width in a direction orthogonal to a transport direction of each of the recording media longer than a maximum width of the various types of recording media, and a slave roller which is provided with a slave roll portion capable of pinching the various types of recording media between the drive roll portion and the slave roll portion, a distance between the ends of the slave roll portion in a direction orthogonal to the transport direction is shorter than a minimum width of the various types of recording media.

### BACKGROUND

1. Technical Field

The present invention relates to a recording apparatus such as an ink jet printer and a recording method.

2. Related Art

In the past, an ink jet recording apparatus, which performs printing on recording media such as paper by ejecting ink through a nozzle of a recording head, has been known as one type of recording apparatuses (for example, see JP-A-2006-248688). In a recording apparatus disclosed in JP-A-2006-248688, each of the recording media is pinched between a roller element (drive roll portion) of a transport drive roller (drive roller) and a roller element (slave roll portion) of a transport slave roller (slave roller), so as to be transported onto a platen. On the platen, printing is performed on each of the recording media by ejecting ink through a nozzle of a recording head.

In general, in the recording apparatus as disclosed in JP-A-2006-248688, in order to transport the recording media smoothly, both ends of a supporting shaft of the transport slave roller are urged toward the transport drive roller by springs or the like. The pinching force of both roller elements applied to each of the recording media may be increased by the springs. Further, in this recording apparatus, as illustrated in the drawing (FIG. 3) of JP-A-2006-248688, a length of the roller element of the transport slave roller in the direction orthogonal to the transport direction of the recording media is longer than the widths of the recording media.

Thus, a load applied to the recording media by the roller element of the transport slave roller with the urging force of the spring is greater at both ends than that at the center of the roller element of the transport slave roller. Accordingly, distribution of the load applied on each of the recording media by the roller element of the transport slave roller is changed depending on the widths of the recording media. Meanwhile, if the widths of the recording media to be used in the recording apparatus are changed, transport characteristics of the transport drive roller and transport slave roller may change according to the widths of recording media. Therefore, accuracy of a recording process may also change according to the recording media.

### SUMMARY

An advantage of some aspects of the invention is to provide a recording apparatus and a recording method capable of suppressing a transport characteristic of recording media from changing even in the case where the width of each of the recording media transported onto a recording area is changed.

In order to solve the above problem, a recording apparatus according to an aspect of the invention is a recording apparatus which includes a recording unit capable of performing a recording process in a recording area for various types of recording media in different widths, and a transport roller pair capable of pinching each of the recording media therebetween and transporting it onto the recording area: in the recording apparatus, the transport roller pair includes; a drive roller which is provided with a drive roll portion having a width in a direction orthogonal to a transport direction of each of the recording media longer than a maximum width of the various types of recording media capable of undergoing the recording process performed by the recording unit, capable of making contact with each of the recording media, which is rotationally driven; and a slave roller which is provided with a slave roll portion capable of pinching the various types of recording media between the drive roll portion and the slave roll portion, which performs slave rotation in accordance with the drive roller rotationally driven; a distance between ends of the slave roll portion in a direction orthogonal to the transport direction of each of the recording media is shorter than a minimum width of the various types of recording media capable of undergoing the recording process performed by the recording unit.

According to the aspect of the invention, the distance between the ends of the slave roll portion in the direction orthogonal to the transport direction of each of the recording media is shorter than the minimum width of the various types of recording media capable of undergoing the recording process performed by the recording unit. Therefore, regardless of the width of each of the recording media transported onto the recording area, a pinching position and a pinching load of the transport roller pair with respect to each of the recording media are always constant. Accordingly, even in the case where the width of each of the recording media transported onto the recording area is changed, it is possible to suppress the transport characteristic of each of the recording media from changing.

In the recording apparatus according to the invention, it is preferable that the drive roll portion include a high friction section for increasing a frictional force to be generated between the drive roll portion and each of the recording media when each of the various types of recording media is transported therethrough, and a distance between the ends of the high friction section in the direction orthogonal to the transport direction of each of the recording media be longer than the maximum width of the various types of recording media capable of undergoing the recording process performed by the recording apparatus.

According to the aspect of the invention, the frictional force generated between the drive roll portion and each of the recording media is increased by the high friction section, therefore, it is possible to suppress each of the recording media from sliding with respect to the drive roll portion.

In the recording apparatus according to the invention, it is preferable that at least one of the high friction section of the drive roll portion and the slave roll portion be formed in a continuous manner in the direction orthogonal to the transport direction of the recording media. According to the aspect of the invention, it is possible to increase the contact surface areas between the high friction section, drive roll portion, and each of the recording media.

In the recording apparatus according to the invention, it is preferable that each of the various types of recording media be transported such that the central portion thereof corresponds to both the central portion of the drive roll portion and the central portion of the slave roll portion in a direction orthogonal to the transport direction of each of the various types of recording media.

According to the aspect of the invention, regardless of the widths of the recording media, the position on each of the recording media pinched between the slave roll portion and the drive roll portion is always set to be constant. Accordingly, it makes it possible to transport each of the recording media onto the recording area stably in a balanced manner regardless of the widths of the recording media.

A recording method according to an aspect of the invention is a recording method for performing a recording process in a recording area on various types of recording media having different widths from each other, after each of the recording media is pinched between a drive roller and a slave roller so as to be transported onto the recording area, the recording method includes: using a roller as a drive roller that includes a drive roll portion, having a width in a direction orthogonal to a transport direction of the recording media, being longer than a maximum width of various types of recording media capable of undergoing the recording process performed by the recording unit, and being capable of making contact with the recording media; and using a roller as a slave roller that includes a slave roll portion being capable of pinching each of various types of recording media between the drive roll portion and the slave roll portion, and that performs slave rotation in accordance with the drive roller, which is rotationally driven, in which a distance between ends of the slave roll portion in the direction orthogonal to the transport direction of each of the recording media is shorter than a minimum width of the various types of recording media capable of undergoing the recording process performed by the recording unit.

According to the aspect of the invention, it is possible to achieve the same effects as those achieved by the recording apparatus configured as described above.

### BRIEF DESCRIPTION OF THE DRAWINGS

The invention will be described with reference to the accompanying drawings, wherein like numbers reference like elements.

FIG. 1 is a side view schematically illustrating an ink jet printer according to an embodiment.

FIG. 2 is a diagram schematically illustrating a state in which a paper is transported by a transport roller pair of the ink jet printer.

FIG. 3 is a graph illustrating a relationship between a transport error of the paper and a transport amount of the paper when the paper is transported by the transport roller pair of the ink jet printer.

FIG. 4 is a graph, for the case where the width of the slave roll portion of the transport roller pair is set to be longer than the maximum width of the paper, illustrating a relationship between the transport error of the paper and the transport amount of the paper when the paper is transported by the transport roller pair.

FIG. 5 is a cross-sectional view schematically illustrating the drive roll portion of the transport roller pair.

FIG. 6 is a diagram schematically illustrating a state in which the paper is transported by a transport roller pair according to a variation.

### DESCRIPTION OF EXEMPLARY EMBODIMENTS

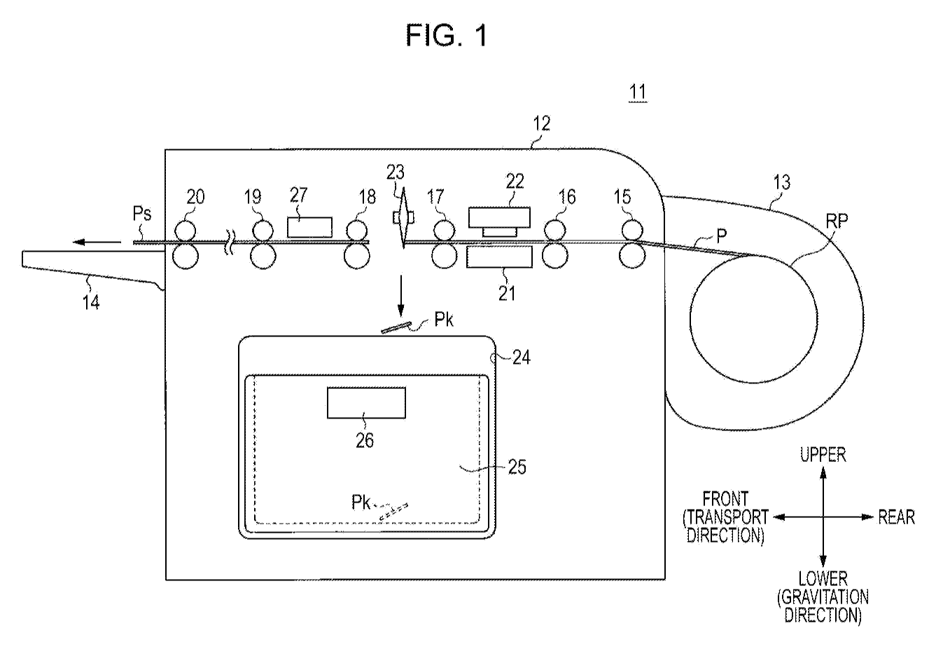

Hereinafter, one embodiment, in which the invention is embodied in a recording apparatus that performs printing as a printing process on a paper P as a long belt-shaped recording medium fed from a roll paper RP wounded in roll form, is described with reference to the drawings. Meanwhile, in order to make the following description understandable, the direction of gravitation is referred to as the “lower direction”, whereas the reverse direction of gravitation is referred to as the “upper direction”, as illustrated in FIG. 1. Further, the direction orthogonal to the upper-lower direction, which is the transport direction for the fed paper P to be transported when printing process is performed, is referred to as the “front direction”, while the direction opposite to the transport direction is referred to as the “rear direction”. In addition, directions that are orthogonal to both of the direction of gravitation and the transport direction are referred to as the “right direction” (near side direction on the paper surface) and the “left direction” (far side direction on the paper surface) when seen from front side, respectively.

As illustrated in FIG. 1, an ink jet printer 11 as a recording apparatus is provided with a main case unit 12 formed substantially in a rectangular parallelepiped shape. A paper case 13 formed substantially in a hollow cylindrical-column shape, which stores the roll paper RP (continuous paper), is disposed on the upper portion of the rear surface of the main case unit 12. On the other hand, a discharge paper tray 14 formed substantially in a rectangular-plate shape is disposed on the upper portion of the front surface of the main case unit 12.

On the upper portion inside the main case unit 12, a plurality of roller pairs 15 through 20 (in this embodiment, six pairs), each of which is configured of a pair of upper and lower rollers for transporting the paper P fed from the roll paper RP stored inside the paper case 13, are disposed respectively in the front-rear direction with intervals being spaced appropriately therebetween.

In the order from the rear side (upstream side) to the front side (downstream side) of a transportation path of the paper P, each of the roller pairs 15 through 20 is referred to as a feeding roller pair 15, a transport roller pair 16, a first intermediate roller pair 17, a second intermediate roller pair 18, a third intermediate roller pair 19, and a discharge roller pair 20, respectively. Each of the roller pairs 15 through 20 is capable of rotating around an axis line extending in the right-left direction that is the direction orthogonal to the transport direction of the paper P.

In each of the roller pairs 15 through 20, a roller positioned on the lower side is rotationally driven by a driving motor (not shown), whereas a roller positioned on the upper side performs slave rotation, respectively. As a result of the roller pairs 15 through 20 being rotationally driven, the paper P that is fed from the roll paper RP is pinched between each of the roller pairs 15 through 20, and transported onto the discharge paper tray 14 along the transportation path.

A supporting table 21 for supporting the paper P from the lower side is disposed on a location between the transport roller pair 16 and the first intermediate roller pair 17 which corresponds to the lower side position of the paper P. On the other hand, a recording head 22 serving as a recording unit is disposed on a location between the transport roller pair 16 and the first intermediate roller pair 17 which is opposite from the supporting table 21, with the paper P therebetween. The recording head 22 performs printing as a recording process by causing ink to be ejected through a nozzle (not shown) onto the paper P supported by the supporting table 21. Accordingly, an area on the upper side surface of the supporting table 21 serves as a printing area, that is, a recording area.

Incidentally, the recording head 22 can be configured of a so-called serial type recording head which is mounted on a carriage moving in a width direction (right-left direction) of the transported paper P, or a so-called line-head type recording head in which a head that is fixedly disposed along the width direction of the paper P is provided with nozzles formed along substantially in the paper width.

A rotary blade 23 is disposed on a location between the first intermediate roller pair 17 and the second intermediate roller pair 18. The rotary blade 23 is rotationally driven around the axis line that is extending along the front-back direction parallel to the transport direction of the paper P, and configured so as to be capable of moving in the right-left direction. The rotary blade 23 is rotationally driven and moved in the right-left direction, so as to cut off the paper P in accordance with every image area printed on the paper P. At this time, the rotary blade 23 also cuts off an unnecessary area present at the edge portion in the transport direction of the image area of the paper P.

On the right side surface of the main case unit 12, a concaved portion 24 is formed so that the surface thereof is slightly concaved therefrom. A paper chip container 25 is housed inside the concaved portion 24 so as to receive and store paper chips Pk generated and fallen downward in the direction of gravity while the paper P is cut by the rotary blade 23. In this case, the paper chip container 25 is located in a position lower than the rotary blade 23, which is the position corresponding to the position of the paper P being cut by the rotary blade 23.

The paper chip container 25 is formed in a rectangular box shape whose upper end is open, and capable of being drawn out from the main case unit 12 in the right direction orthogonal to the transport direction of the paper P. The paper chip container 25 is disposed so that the right side surface thereof is exposed from the concaved portion 24. Further, a handle 26, which allows a user to hold when the paper chip container 25 is drawn out from the main case unit 12, is disposed on the upper end portion on the right side surface of the paper chip container 25.

A dryer 27 which dries a paper Ps that has been printed by the recording head 22 and cut by the rotary blade 23 is disposed on a location between the second intermediate roller pair 18 and the third intermediate roller pair 19. Meanwhile, in this embodiment, the recording head 22 of the ink jet printer 11 is capable of performing printing on the paper P in three types of widths, that is, 4 inches, 8 inches, and 12 inches. The paper P in each of these widths is transported so that the central portion thereof in the right-left direction corresponds with the central portion of each of the roller pairs 15 through 20 in the right-left direction.

Next, a configuration of the transport roller pair 16 is described in detail.

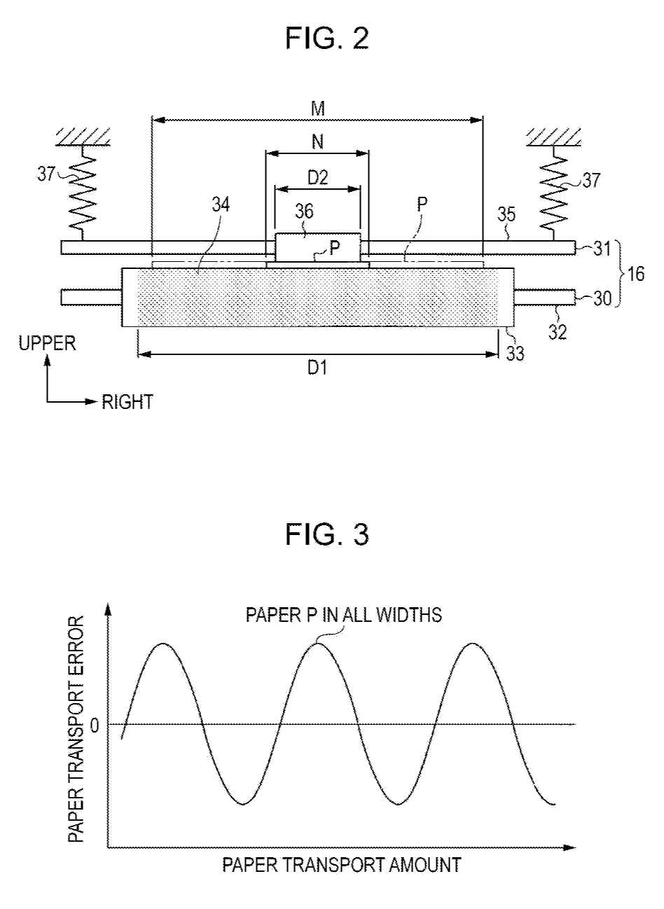

As illustrated in FIG. 2, the transport roller pair 16 which transports the paper P onto the printing area includes a drive roller 30 that is rotationally driven by the drive motor (not shown), and a slave roller 31 that performs slave rotation in accordance with the drive roller 30 rotationally driven. The drive roller 30 includes a drive rotation shaft 32, and a cylinder-shaped drive roll portion 33 disposed on the drive rotation shaft 32 so as to be capable of making contact with the paper P. The drive roll portion 33 is configured of a material having rigidity such as metal or the like. In the right-left direction orthogonal to the transport direction of the paper P, length of the drive roll portion 33 is set to be slightly longer than the maximum width M (in this embodiment, 12 inches) of various types of papers P that can be printed by the ink jet printer 11.

On the surface (circumference surface) of the drive roll portion 33, a high friction section 34 is formed in a continuous manner in the right-left direction, so that a frictional force generated between the paper P and the drive roll portion 33 when the paper P is transported is increased. The high friction section 34 is configured of wear-resistant particles, and an adhesive layer onto which the wear-resistant particles are evenly dispersed, which firmly holds the wear-resistant particles in a state in which the tip end of wear-resistant particles in the radial direction of the drive roll portion 33 are partially exposed on the surface thereof. Ceramics such as alumina or silicon carbide is used as wear-resistant particles. In this embodiment, alumina is employed as the wear-resistant particles.

On the other hand, adhesive materials including coating materials are used as the adhesive layer. Specifically, a thermosetting type epoxy adhesive, a room temperature curable type acrylic adhesive, an ultraviolet curable polyurethane adhesive, or a two-component reactive type epoxy adhesive can be used as the adhesive layer. In this embodiment, a room temperature curable type acrylic adhesive is employed as the adhesive layer. Meanwhile, a distance D1 between the ends in the right-left direction of the high friction section 34 formed on the surface of the drive roll portion 33 is set to be a little longer than the maximum width M of the paper P.

The slave roller 31 includes a slave rotation shaft 35, and a cylinder-shaped slave roll portion 36 which is disposed on the central portion in the right-left direction of the slave rotation shaft 35 so as to pinch the paper P between the drive roll portion 33 and the slave roll portion 36. The slave roll portion 36 is formed of a flexible material such as urethane rubber, and extended continuously in the right-left direction. Both ends of the slave rotation shaft 35 are continuously biased toward the lower side, that is, the side of the drive roller 30, by a pair of coil springs 37. Accordingly, a biasing force of each coil spring 37 acts on the paper P as a pinching force caused by the slave roll portion 36 and the drive roll portion 33. In this case, each coil spring 37 is set so as not to interrupt the rotation of the slave rotation shaft 35.

A distance D2 between the ends in the right-left direction of the slave roll portion 36 is set to be slightly shorter than the minimum width N (in this embodiment, 4 inches) of various types of papers P that can be printed by the recording head 22 of the ink jet printer 11. Meanwhile, in FIG. 2, the paper P in the minimum width N is indicated by a solid line, whereas the paper P in the maximum width M is indicated by a dashed two-dotted line.

Next, operations of the ink jet printer 11 are described.

At first, when each of the roller pairs 15 through 20 is rotationally driven, the paper P that has been uncoiled from the roll paper RP is transported onto the transport roller pair 16 by the feeding roller pair 15. The paper P that has been transported to the transport roller pair 16 is pinched between the transport roller pair 16, and transported onto the printing area that is the area on the upper surface of the supporting table 21. Thereafter, the paper P is printed by receiving ink ejected from the recording head 22.

At this time, the paper P is transported in such a manner that the central portion thereof in the right-left direction corresponds to both the central portion of the drive roll portion 33 and the central portion of the slave roll portion 36. In addition, the distance D2 between the ends of the slave roll portion 36 in the right-left direction is shorter than the minimum width N of the paper P. With this, regardless of the width of the paper P in use, the pinching position and pinching load of the transport roller pair 16 with respect to the paper P become constant.

Accordingly, a transport error of the paper P by the transport roller pair 16 with respect to a transport amount of the paper P transported onto the printing area is substantially constant for the papers P in all widths, as illustrated in a waveform in FIG. 3. As a result, even in the case where the width of the paper P transported onto the printing area is changed, a transport characteristic (transport error) of the paper P is hardly be changed. Therefore, printing accuracy becomes stable among the papers P in various types of widths.

Incidentally, as in a same manner as in the past, if the distance D2 between the ends of the slave roller portion 36 in the right-left direction of the transport roller pair 16 is set to be longer than the maximum width M of the paper P, because the both ends of the slave rotation shaft 35 are biased toward the side of the drive roller 30 by the respective coil springs 37, the pinching position and the pinching load of the transport roller pair 16 with respect to the paper P is changed depending on the width of the paper P. In other words, distribution of the load applied on the paper P by the slave roller portion 36 in accordance with the biasing force from each coil spring 37 is changed depending on the width of the paper P.

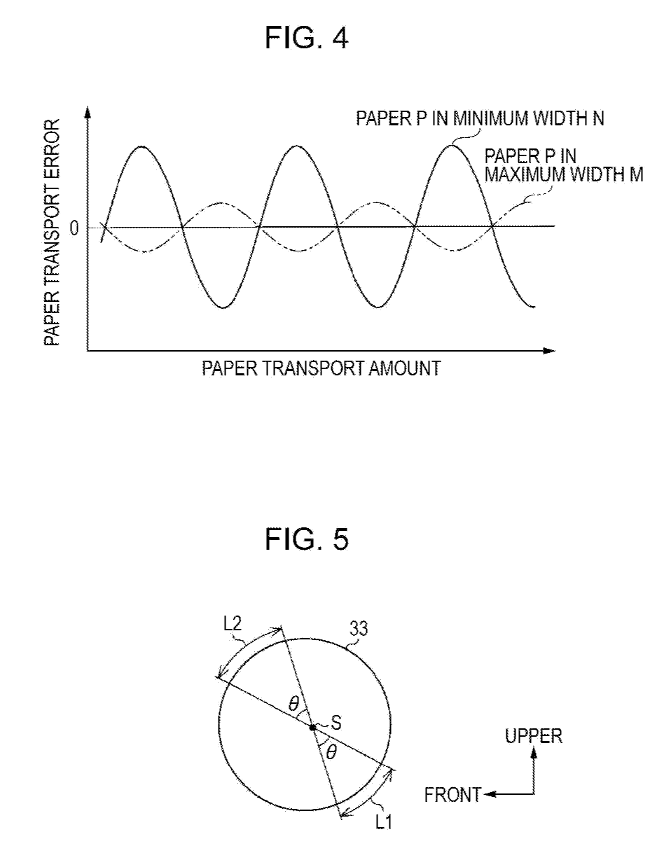

As a result, as illustrated in waveforms in FIG. 4, the transport error of the paper P by the transport roller pair 16 with respect to the transport amount of the paper P transported to the printing area is changed between the paper P in the minimum width N (waveform indicated in the solid line in FIG. 4) and the paper P in the maximum width M (waveform indicated in the dashed two-dotted line in FIG. 4). That is, between the paper P in the minimum width N and the paper P in the maximum width M, the waveforms thereof which indicate the transport error of the paper P by the transport roller pair 16 with respect to the transport amount of the paper P transported to the printing area exhibit differences in amplitude as well as phase. Accordingly, in the case where the width of the paper P transported onto the printing area is changed, the transport characteristic (transport error) of the paper P is also changed, and therefore, it is problematic in that the printing accuracy becomes unstable.

Further, in general, the drive roll portion 33 (drive roller 30) is formed such that the cross-sectional shape thereof is not a perfect circle with respect to a rotating center S, as illustrated in FIG. 5. Therefore, because the rotating center S of the drive roll portion 33 is decentered, the transport amount of the paper P when the drive roll portion 33 is rotated by an angle θ differs depending on the distance from the rotating center S, for example.

Accordingly, in the case where the drive roll portion 33 is rotated by the angle θ, a transport amount L1 for the position on the circumference surface of the drive roll portion 33, the distance of which is relatively close from the rotating center S, is less than a transport amount L2 for the position on the circumference surface of the drive roll portion 33, the distance of which is relatively far from the rotating center S. Therefore, in order to eliminate such variations in transport amount, in general, taking the decentering of rotating center S of the drive roll portion 33 into consideration, the drive roller 30 rotationally driven is precisely controlled, so that the transport amount of the paper P caused by the drive roll portion 33 becomes constant in the entire circumference.

However, such transport amount of the paper P is fluctuated depending on the transport characteristic of the paper P caused by the difference between each width of the paper P, the controlling of the drive roller 30 which is rotationally driven needs to be adjusted for each width of the paper P. Accordingly, as in the past, if the transport characteristic of the paper P is changed in each width of the paper P transported onto the printing area, an adjustment value is required to be set for each width of the paper P. As a result, a load which arises from an adjustment process on a transport condition of the paper P by the transport roller pair 16 is increased.

In this regard, in the embodiment, the transport characteristic of the paper P is hardly changed even if the width of paper P transported onto the printing area is changed. Therefore, regardless of the width type of the paper P, a single value can be set as the aforementioned adjustment value, so that the load which arises from the adjustment process on the transport condition of the paper P by the transport roller pair 16 can be reduced.

Next, the paper P that is printed in the printing area is transported onto the second intermediate transport roller pair 18 by the first intermediate transport roller pair 17. At this moment, the paper P is cut along in the right-left direction for each image area by the rotary blade 23. Furthermore, the paper P is cut in such a manner that the unnecessary area thereof present at the edge portion in the transport direction of the image area is cut off by the rotary blade 23 as well. The paper chips Pk, which are cut off from the paper P, fall downward and are stored within the paper chip container 25.

Thereafter, the paper Ps, which is cut by the rotary blade 23 for each image area, is transported toward the third intermediate roller pair 19 by the second intermediate roller pair 18. At this time, the printed surface side of the paper Ps is dried by the dryer 27. Subsequently, the paper Ps that has been dried by the dryer 27 is transported toward the discharge roller pair 20 by the third intermediate roller pair 19, and discharged onto the discharge paper tray 14 by the discharge roller pair 20.

In this manner, according to the aspect of the embodiment described thus far, it is possible to achieve the following effects.

1. In the right-left direction orthogonal to the transport direction of the paper P, the distance D2 between the ends of the slave roll portion 36 is set to be slightly shorter than the minimum width N of various types of papers P that can be printed by the recording head 22. Therefore, regardless of the width of the paper P transported onto the recording area, the pinching position and pinching load of the transport roller pair 16 with respect to the paper P are always constant. Accordingly, even in the case where the width of the paper P transported onto the recording area is changed, it is possible to suppress the transport characteristic of the paper P from changing. As a result, it is possible to make the printing accuracy stable among the papers P in various types of paper widths.

Further, even if the width of the paper P transported onto the printing area is changed, the transport characteristic of the paper P is hardly changed. Thus, regardless of the width type of the paper P, a single adjustment value for controlling the drive roller 30 may be set to cancel the transport error of the paper P. Therefore, the load due to the adjustment process on the transport condition of the paper P by the transport roller pair 16 can be reduced.

2. In the right-left direction orthogonal to the transport direction of the paper P, the distance D1 between the ends of the high friction section 34 on the drive roll portion 33 is set to be longer than the maximum width M of various types of papers P that can be printed by the recording head 22. Therefore, regardless of the width of the paper P, the frictional force generated between the paper P and the drive roll portion 33 can be sufficiently increased by the high friction section 34. Accordingly, it is possible to suppress the paper P from sliding with respect to the drive roll portion 33. In particular, when the paper P is cut by the rotary blade 23, a force in the right-left direction acts on the paper P, however, even in that case, it is possible for the high friction section 34 to efficiently suppress the paper P from sliding in the right-left direction, as a result. Accordingly, it makes it possible to transport the paper P in a stable manner with high accuracy.

3. The high friction section 34 and the slave roll portion 36 are provided in a continuous manner in the right-left direction orthogonal to the transport direction of the paper P. Therefore, it is possible to increase the contact surface areas between the high friction section 34, slave roll portion 36, and the paper P.

4. In the direction orthogonal to the transport direction of the paper P, the paper P in each width is transported so that the central portion thereof corresponds to both the central portion of the drive roll portion 33 and the central portion of the slave roll portion 36. Therefore, regardless of the width of the paper P, the position on the paper P which is pinched between the slave roll portion 36 and the drive roll portion 33 is always constant.

Accordingly, regardless of the width of the paper P, it is possible to transport the paper P onto the printing area stably in a balanced manner. Variations

It may as well be possible for the aforementioned embodiments to be changed as the following embodiments.

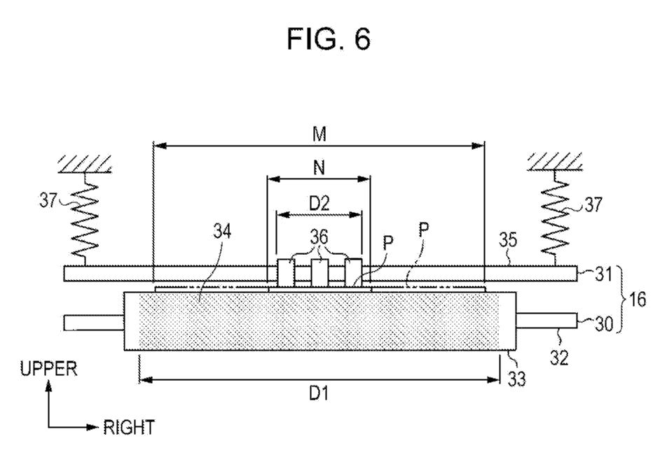

As illustrated in FIG. 6, in the right-left direction orthogonal to the transportation direction of the paper P, the slave roll portion 36 may be disposed on the slave rotation shaft 35 in a discontinuous manner.

In the right-left direction orthogonal to the transportation direction of the paper P, the high friction section 34 may be formed on the surface (circumference surface) of the drive roll portion 33 in a discontinuous manner.

The distance D1 between the ends in the right-left direction of the high friction section 34 formed on the surface of the drive roll portion 33 may not necessarily be longer than the maximum width M of the paper P. The distance D1 between the ends in the right-left direction of the high friction section 34 may be equal to or less than the maximum width M of the paper P.

The high friction section 34 may not necessarily be formed on the surface of the drive roll portion 33.

The high friction section 34 may be formed by roughening the surface of the drive roll portion 33, or winding rubber around the surface of the drive roll portion 33.

In the right-left direction orthogonal to the transport direction of the paper P, the paper P in each width may not necessarily be transported in such a manner that the central portion thereof corresponds to the central portion of the drive roll portion 33 and the central portion of the slave roll portion 36, respectively.

In addition to the roll paper (continuous paper) RP, sheets of paper may as well be used as the recording media.

In the ink jet printer 11, the recording media may be plastic films, fabrics, metal foils, and the like.

In the above embodiments, the recording apparatus is embodied in the ink jet printer 11, however, the recording apparatus may also be embodied in the liquid ejecting apparatus which ejects and discharges the liquid other than the ink. The invention can be applied to various types of liquid ejecting apparatuses provided with a liquid ejecting head or the like which discharges a small amount of liquid droplets. Meanwhile, the terminology “liquid droplets” represents a state of liquid which is discharged from the above mentioned liquid ejecting apparatus, and may include the liquid droplets in a granular form, in a teardrop form, and the liquid droplets having string-like trails threrebehind. In addition, the terminology “liquids” here may indicate any materials that can be ejected from the liquid ejecting apparatuses. For example, the materials can be substances in a liquid-phase state, and include not only liquids with high/low viscosity, fluids of sol, gel water, the other fluids such as an inorganic solvent, an organic solvent, a liquid solution, a liquid resin, a liquid metal (metallic melt), and a liquid as one state of substance, but also substances in which particles of functional materials consisting of solid matter such as pigments and metallic particles are dissolved, dispersed or mixed into a solvent. Meanwhile, the ink described in the aforementioned embodiments and liquid crystals can be given as representative examples of the liquids. Here, the terminology “ink” may include various liquid compositions such as typical water-based ink, oil-based ink, as well as gel ink, hot-melt ink, and so on. Further, the specific examples of the liquid ejecting apparatus include: a liquid ejecting apparatus for ejecting a liquid which includes the materials such as an electrode material and a coloring material in a form of dispersion or solution, which is used for manufacturing a liquid crystal display, an electroluminescence (EL) display, a field emission display, a color filter, and so on; a liquid ejecting apparatus for ejecting a bioorganic material used for manufacturing biochips; a liquid ejecting apparatus for ejecting a liquid used for a precision pipette and serving as a sample; a printing apparatus; a micro-dispenser; and so on. Other examples of the liquid ejecting apparatus further include: a liquid ejecting apparatus for precisely ejecting lubricant oil onto a precision apparatus such as a watch and a camera and the like; a liquid ejecting apparatus for ejecting transparent resin droplets such as UV-curable resin and the like onto a substrate to form a micro-hemispherical lens (optical lens) used for an optical communication element; and a liquid ejecting apparatus for ejecting an acid or alkaline etching solution so as to perform etching on a substrate and the like, and the invention is thus applicable to any one type of the liquid ejecting apparatus.

The entire disclosure of Japanese Patent Application No. 2011-126160, filed Jun. 6, 2011 is expressly incorporated by reference herein.

What is claimed is:

1. A recording apparatus, comprising:
a recording unit capable of performing a recording process in a recording area for various types of recording media in different widths; and
a transport roller pair capable of pinching each of the recording media therebetween and transporting the recording media onto the recording area;
wherein the transport roller pair includes;
a drive roller which is provided with a drive roll portion having a width in a direction orthogonal to a transport direction of each of the recording media longer than a maximum width of the various types of recording media capable of undergoing the recording process performed by the recording unit, capable of making contact with each of the recording media, which is rotationally driven; and
a slave roller which is provided with a slave roll portion capable of pinching the various types of recording media between the drive roll portion and the slave roll portion, which performs slave rotation in accordance with the drive roller which is rotationally driven;
wherein a distance between ends of the slave roll portion in a direction orthogonal to the transport direction of each of the recording media is shorter than a minimum width of the various types of recording media capable of undergoing the recording process performed by the recording unit.

2. The recording apparatus according to claim 1,
wherein the drive roll portion includes a high friction section for increasing a frictional force to be generated between the drive roll portion and each of the recording media when each of the various types of recording media is transported therethrough;
a distance between ends of the high friction section in the direction orthogonal to the transport direction of each of the recording media is longer than a maximum width of the various types of recording media capable of undergoing the recording process performed by the recording apparatus.

3. The recording apparatus according to claim 2, wherein at least one of the high friction section of
the drive roll portion and the slave roll portion is formed in a continuous manner in the direction orthogonal to the transport direction of the recording media.

4. The recording apparatus according to claim 1,
wherein each of the various types of recording media is transported such that the central portion thereof corresponds to both the central portion of the drive roll portion and the central portion of the slave roll portion in a direction orthogonal to the transport direction of each of the various types of recording media.

5. A recording method for performing a recording process in a recording area on various types of recording media having different widths from each other, after each of the recording media is pinched between a drive roller and a slave roller so as to be transported onto the recording area, the recording method comprising:
using a roller as a drive roller that includes a drive roll portion, having a width in a direction orthogonal to a transport direction of the recording media, being longer than a maximum width of various types of recording media capable of undergoing the recording process performed by the recording unit, and being capable of making contact with the recording media; and
using a roller as a slave roller that includes a slave roll portion being capable of pinching each of various types of recording media between the drive roll portion and the slave roll portion, and that performs slave rotation in accordance with the drive roller, which is rotationally driven, in which a distance between ends of the slave roll portion in the direction orthogonal to the transport direction of each of the recording media is shorter than a minimum width of the various types of recording media capable of undergoing the recording process performed by the recording unit.
